(19) United States
(12) Patent Application Publication
(10) Pub. No.: US 2016/0080861 A1
(43) Pub. Date: Mar. 17, 2016

(54) DYNAMIC MICROPHONE SWITCHING

(71) Applicant: Toyota Motor Engineering & Manufacturing North America, Inc., Erlanger, KY (US)

(72) Inventors: Sean L. Helm, Saline, MI (US); Jeffrey E. Pierfelice, Canton, MI (US); Eric R. Schmidt, Northville, MI (US)

(21) Appl. No.: 14/487,268

(22) Filed: Sep. 16, 2014

(51) Int. Cl. H04R 1/32; B60R 11/02

(52) U.S. Cl. CPC H04R 1/326; B60R 11/0247; H04R 2410/01; H04R 2499/13

(57) ABSTRACT

Disclosed are computer devices, systems, and methods for dynamic microphone switching for a vehicle. A plurality of microphones can be located throughout the vehicle cabin, each biased toward a different seat. When audio is received from the microphones, the volumes of the audio input for each respective microphone can be compared. The microphone with the loudest audio input can be activated and the audio input can be sent to an application, such as a telephone application. The other microphones can be muted and their audio inputs discarded. A baseline threshold can be used to determine if audio input detected by a microphone is intentional or is merely ambient noise. Weight sensors in each seat can also be used to determine whether a microphone should be activated. For example, if nobody is sitting in a particular seat, then that microphone can automatically be muted.

### BACKGROUND

Hands-free phone systems for vehicles allow a driver to talk on the phone without taking his or her hands off the wheel or eyes off the road. These systems often connect to a mobile phone through a Bluetooth or similar wireless connection and utilize the vehicle's audio system including speakers and a microphone. Because these systems are generally designed to aid the driver, the microphone included in the vehicle's audio system is often configured to be biased toward a single direction, specifically toward the driver's seat. Such a unidirectional microphone is desirable because it is less likely to pick up ambient noise, which could be a distraction to the driver or a counterparty to a phone call.

However, the downside of a unidirectional microphone biased toward the driver is that if a passenger wishes to speak on the phone call, it can be difficult for the passenger to be heard. On the other hand, a microphone that can pick up audio input throughout the vehicle cabin can be more susceptible to ambient noise.

### SUMMARY

Disclosed herein are computer devices, systems, and methods for dynamic microphone switching for a vehicle. A plurality of microphones can be located throughout the vehicle cabin, each biased toward a different seat. When audio inputs are detected by the microphones, the volumes of the audio input for each respective microphone can be compared. The microphone with the loudest audio input can be activated, that is, the audio input can be sent to an application, such as a telephone application. The other microphones can be muted, that is, the audio inputs can be discarded. In addition, a minimum volume threshold can be used to determine if an audio input detected by a microphone is intentional or is merely ambient noise. Weight sensors in each seat can also be used to determine whether a microphone should be activated. For example, if there is no occupant sitting in a particular seat, then that microphone can automatically be muted.

In one implementation, a computing device for a vehicle is disclosed. The computing device includes: one or more processors for controlling operations of the computing device; and a memory storing data and program instructions used by the one or more processors, wherein the one or more processors execute instructions stored in the memory to: receive a first audio input from a first microphone biased toward a first seat within the vehicle; receive a second audio input from a second microphone biased toward a second seat within the vehicle; compare the first audio input and the second audio input to determine which is louder and which is quieter; and discard the quieter of the first audio input and the second audio input.

In another implementation, a computer-implemented method for a vehicle is disclosed. The method includes: receiving a first audio input from a first microphone biased toward a first seat within the vehicle; receiving a second audio input from a second microphone biased toward a second seat within the vehicle; comparing the first audio input and the second audio input to determine which is louder and which is quieter; and discarding the quieter of the first audio input and the second audio input.

In another implementation, a system is disclosed, which system includes: a vehicle; at least a first microphone biased toward a first seat within the vehicle and a second microphone biased toward a second seat within the vehicle; a computing device in communication with the first microphone and the second microphone, the computing device comprising one or more processors for controlling operations of the computing device and a memory storing data and program instructions used by the one or more processors, wherein the one or more processors execute instructions stored in the memory to: receive a first audio input from the first microphone; receive a second audio input from the second microphone; compare the first audio input and the second audio input to determine which is louder and which is quieter; and discard the quieter of the first audio input and the second audio input.

### BRIEF DESCRIPTION OF THE DRAWINGS

FIG. 1 is a schematic block diagram of a computing device for dynamic microphone switching;

FIG. 2 is a pictorial representation of a vehicle including the computing device of FIG. 1;

FIG. 3 is a logic flowchart of an example process 300 for dynamic microphone switching; and

FIG. 4 is a block diagram illustrating several scenarios of dynamic microphone switching.

### DETAILED DESCRIPTION

Disclosed herein are computer devices, systems, and methods for dynamic microphone switching for a vehicle. In one implementation, a plurality of microphones can be located throughout the vehicle cabin, each biased toward a different vehicle occupant. For example, one can be biased toward the driver, and another can be biased toward a passenger. The audio inputs from each microphone can be compared with each other to determine which microphone has picked up the loudest audio input. That microphone can be activated, meaning that the audio input from that microphone can be passed through to an application such as a telephone application or other audio-related application. The other microphones, on the other hand, can be muted, meaning that the audio inputs detected by the other microphones that were not as loud can be discarded and not passed through to the application. In addition, a minimum volume threshold can be used to determine if a microphone should be activated or muted. Weight sensors in each seat can also be used to determine whether a microphone should be activated or muted. For example, if there is no occupant sitting in a particular seat, then that microphone can automatically be switched off.

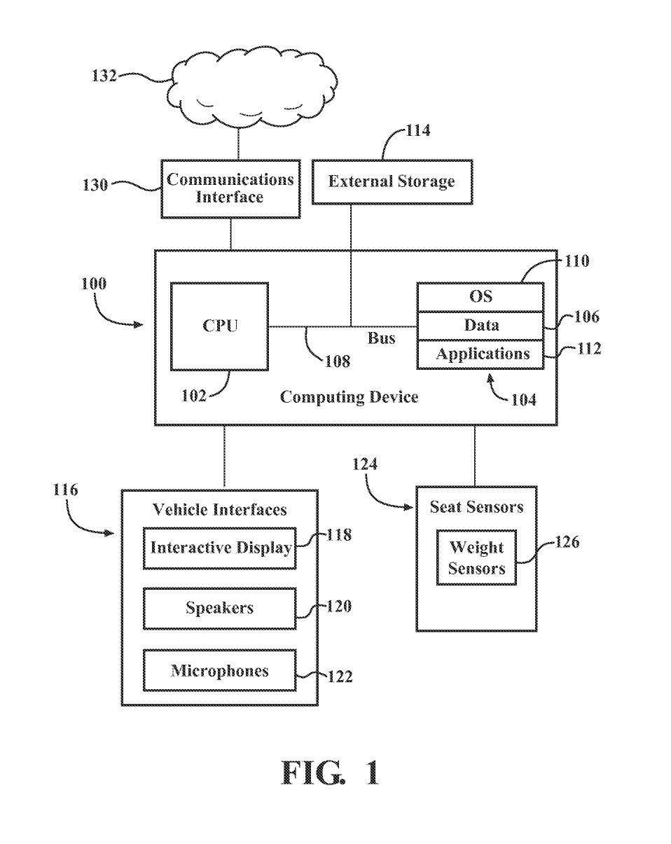

FIG. 1 is a schematic block diagram of a computing device 100 for dynamic microphone switching for a vehicle. The computing device 100 can be any type of vehicle-installed, handheld, desktop, or other form of single computing device, or can be composed of multiple computing devices. A processing unit 102 in the computing device 100 can be a conventional central processing unit (CPU) or any other type of device, or multiple devices, capable of manipulating or processing information. A memory 104 in the computing device 100 can be a random access memory device (RAM) or any other suitable type of storage device. The memory 104 can include data 106 that is accessed by the CPU 102 using a bus 108.

The memory 104 can also include an operating system 110 and installed applications 112, the installed applications 112 including programs or apps that permit the CPU 102 to implement dynamic microphone switching or that are used in conjunction with dynamic microphone switching. The computing device 100 can also include secondary, additional, or external storage 114, for example, a memory card, flash drive, or any other form of computer readable medium. In one implementation, the applications 112 can be stored in whole or in part in the external storage 114 and loaded into the memory 104 as needed for processing.

The computing device 100 can be in direct or indirect communication with one or more vehicle interfaces 116 to control various vehicle functions. Example vehicle interfaces 116 can include an interactive display 118 and elements of an audio system including speakers 120 and microphones 122. In addition, the computing device 100 can be in direct or indirect communication with one or more seat sensors 124 which detect the presence or absence of vehicle 200 occupants. Seat sensors 124 can include weight sensors 126 that can be placed in each seat in the vehicle 200 to detect whether a person is sitting in the seat. Other seat sensors 124 can also be used. For example, one or more optical sensors (i.e., cameras) can be used together with an image recognition module to determine whether a person is sitting in a seat. Other seat sensors 124 that detect the presence or absence of persons can also be used without departing from the spirit or scope of the instant disclosure.

The computing device 100 can also include a communications interface 130 with which the computing device 100 can communicate with external sources through a network 132, such as the internet.

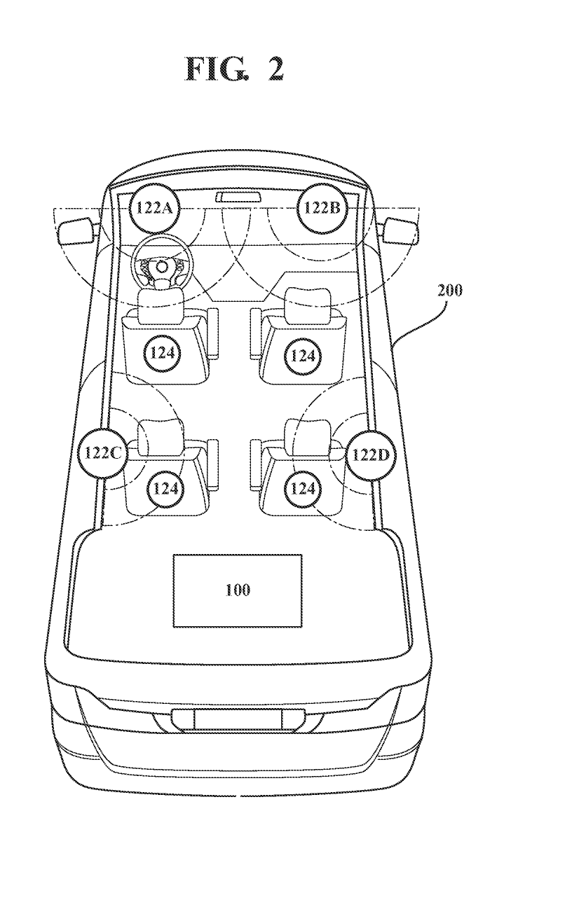

FIG. 2 is a pictorial representation of a vehicle 200 in direct or indirect communication with the computing device 100. The computing device 100 can be located within the vehicle 200 or can be located remotely from the vehicle 200 in an alternate location. If the computing device 100 is remote from the vehicle, the vehicle 200 can include the capability of communicating with the computing device 100, such as through the communications interface 130. A plurality of microphones 122A-D can be placed throughout the vehicle cabin, for example near each seat, and each microphone can be biased toward the occupant of each such seat. To save cost, a microphone 122 can be directed toward a group of seats rather than a single seat without departing from the spirit or scope of the instant disclosure. For example, a microphone 122 can be biased toward the rear row of seats so that it can detect audio input from an occupant sitting in any seat in the rear row (but it would not be configured to detect an occupant sitting in the driver's seat or passenger's seat).

Seat sensors 124 including weight sensors 126 can also be associated with each seat, in order to detect if an occupant is present in that seat.

In one example implementation, the computing device 100 can cause only one microphone 122 to be activated at a time, while the rest of the microphones 122 can be muted. The microphones 122 can be activated or muted based on which occupant is currently speaking. The computing device 100 can pass the audio input received from the activated microphone 122 to an application 112 and discard the audio inputs received from the other, muted, microphones 122. The application 112 can be any application that accepts audio inputs, such as a telephone application. Other applications 112 that accept audio inputs, such as a voice command application for controlling vehicle's 200 entertainment system, climate system, or the like can also be used in conjunction with the instant disclosure.

As an example scenario, the driver may be using the speakers 120 and microphone 122A in the course of talking on the phone to an outside party using a telephone application 112. In accordance with one example implementation, while the driver is speaking, only the microphone 122A biased toward the driver can be made active, with all other microphones 122B-D around the vehicle 200 cabin muted. This can prevent the other microphones 122B-D from interfering with the phone call by picking up ambient noise from around the cabin. During the call, a passenger sitting in the passenger's seat may wish to speak on the phone call as well. If the driver ceases speaking and the passenger begins speaking, the computing device 100 can mute the driver's microphone 122A and activate the passenger's microphone 122B. Then, when the driver begins talking again, the driver's microphone 122A can be activated again and the passenger's microphone 122B can be muted again.

In another example implementation, the audio inputs from each microphone 122 are compared with each other to determine which is loudest. Therefore, even if audio inputs are being detected by more than one microphone 122 simultaneously, only the microphone 122 picking up the loudest audio input can be activated, and the other microphones 122 picking up quieter audio inputs can be muted. Accordingly, ambient noise detected by the other microphones 122 can be discarded and prevented from interfering with the phone call.

In one example implementation, the seat sensors 124, such as the weight sensors 126, can be used to determine whether a microphone 122 should be activated or muted. If an occupant is not sitting in a seat toward which a particular microphone 122 is biased, then any audio input detected by such microphone 122 can be assumed to be ambient noise that should be discarded. For example, the noise could be coming from outside the vehicle 200 (particularly if a window on that side of the vehicle 200 is open), or the driver could have dropped a music player or other audible device, which could have fallen to another side of the vehicle and be heard by a microphone 122 other than the driver side microphone 122A. Based on the seat sensors 124, the computing device 100 can mute any microphone 122 that does not have an occupant sitting in the associated seat (that is, even if some ambient noise is detected by that microphone 122).

In one example implementation, a minimum volume threshold can be predefined so that any audio input detected by a microphone 122 below such threshold can be discarded. The minimum volume threshold can be set at a volume that is lower than an ordinary speaking volume. Accordingly, if a microphone 122 detects audio quieter than the minimum volume threshold, it can be assumed that the audio is merely ambient noise.

In one example implementation, two or more microphones 122 can be activated simultaneously, and the corresponding audio inputs can be passed through to the application 112, but only if the respective audio inputs are approximately equal in volume (i.e., even if one is trivially louder than the others). This can be applicable in a scenario where two occupants of the vehicle 200 wish to join in the conversation simultaneously. In this example scenario, neither of the audio inputs in this example is ambient noise so both should be passed through. However, if the difference in volume between the audio inputs (hereinafter referred to as the “volume gap”) is non-trivial, then only the loudest audio input can be passed through and the corresponding microphone 122 activated, while the other microphones 122 can be muted (it being assumed that they are merely detecting ambient noise). Whether the volume gap is trivial or non-trivial can be based on an absolute volume difference (i.e., a certain predefined number of decibels) or a relative volume difference (i.e., one is a certain predefined percentage louder than the other).

In one example implementation, a visual cue can be displayed to indicate which microphones 122 are activated and which microphones 122 are muted at any given time. For example, a light (such as a light-emitting diode or the like) can be associated with each microphone 122 in the vehicle 200, which light can be turned on if the associated microphone 122 is activated and turned off if the associated microphone 122 is muted. Alternatively, a message or other indication can be displayed on the interactive display 118 indicating which microphone(s) 122 are active. (For example, the interactive display 118 could display a notice such as, “Driver mic active” or “Passenger mic active,” depending on which microphone(s) 122 are active.)

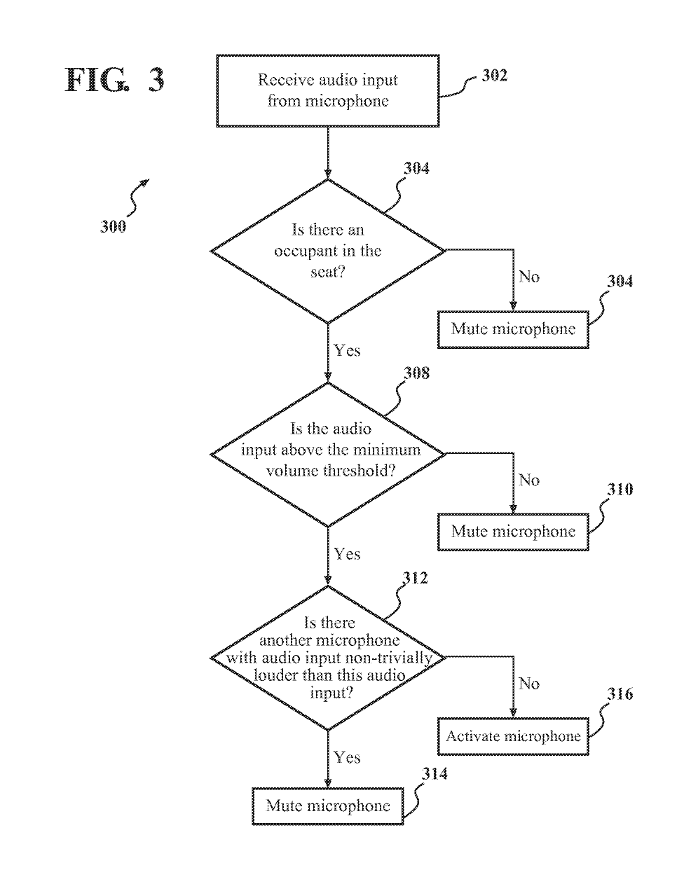

FIG. 3 is a logic flowchart of an example process 300 for dynamic microphone switching. At step 302, the computing device 100 receives an audio input from a microphone 122 biased toward a particular seat (for the purposes of this example process 300, referred to as the “first microphone”). At step 304, the computing device 100 determines, based on the seat sensor 124 of the corresponding seat, whether an occupant is sitting in the seat. If no, then, at step 306, the microphone 122 is muted and the audio input received from such microphone 122 is discarded. If yes, then the process 300 continues to step 308.

At step 308, the computing device 100 determines if the audio input is above the predefined minimum volume threshold. If not, then, at step 310, the microphone 122 is muted and the audio input received from such microphone 122 is discarded. If yes, then the process 300 continues to step 312.

At step 312, the computing device 100 determines if there is another microphone 122 in the vehicle 200 that is simultaneously detecting another audio input that is non-trivially louder (based on the volume gap). If there is such a non-trivially louder audio input, then, at step 314, the first microphone 122 is muted and the audio input received from such microphone 122 is discarded. If not, then, at step 316, the first microphone 122 is activated and the audio input is passed through to the applicable application 112, which can be, for example, a telephone application.

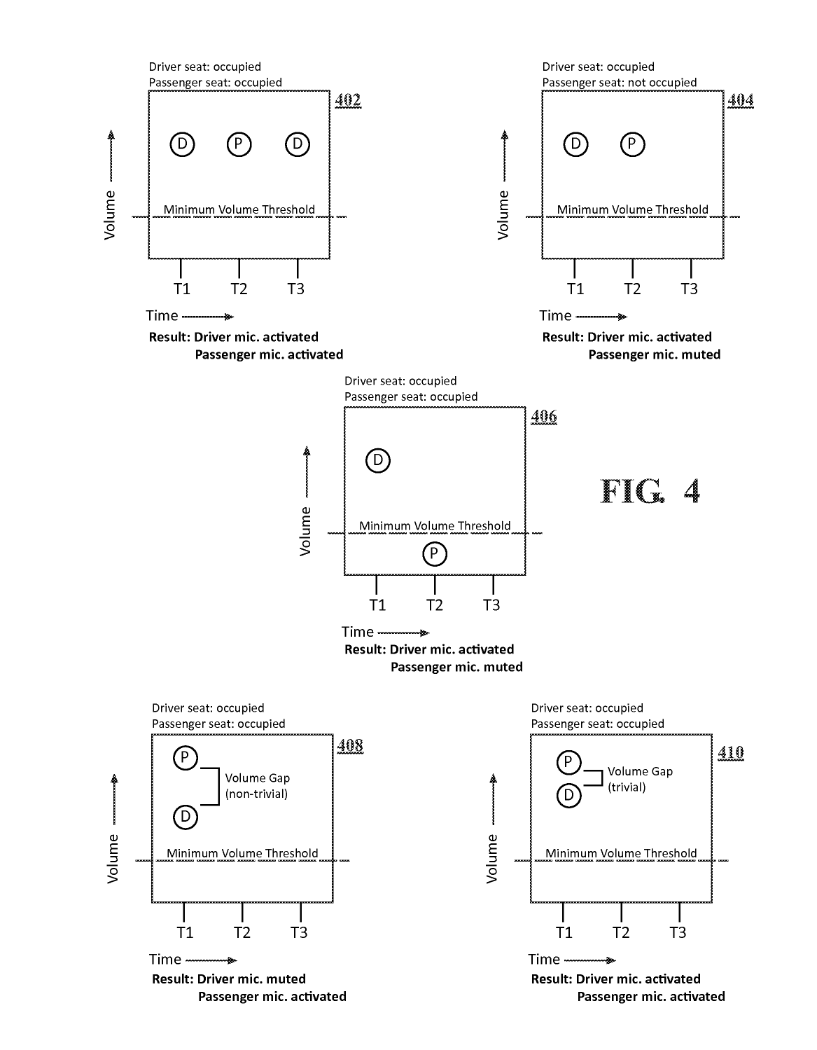

FIG. 4 is a block diagram depicting five example scenarios for dynamic microphone switching where more than one microphone 122 detects audio input. In scenario 402, the driver side microphone 122A detects a driver audio input (depicted as “D”) at time T1. Then, at time T2, the passenger side microphone 122B detects a passenger audio input (depicted as “P”). At time T3, the driver side microphone 122A detects another driver audio input. The seat sensors 124 detect that there are occupants in both the driver seat and the passenger seat. In addition, the driver audio inputs and passenger audio input are all louder than the minimum volume threshold. Accordingly, the computing device 100 activates the driver side microphone 122A for times T1 and T3 and the passenger side microphone 122B for time T2. In other words, all detected audio inputs can be passed through to the application 112.

In scenario 404, the driver side microphone 122A detects a driver audio input at time T1. Then, at time T2, the passenger side microphone 122B detects a passenger audio input. However, based on the seat sensors 124, the computing device 100 determines that there is an occupant in the driver seat but no occupant in the passenger seat. Accordingly, the computing device 100 activates the driver side microphone 122A for its respective audio input but mutes the passenger side microphone 122B for its respective audio input. In scenario 404, it can be assumed that the audio input detected by the passenger side microphone 122B at time T2 was ambient noise that is to be discarded.

In scenario 406, the driver side microphone 122A detects a driver audio input at time T1. Then, at time T2, the passenger side microphone 122B detects a passenger audio input. There is an occupant in each seat. However, the passenger audio input detected at time T2 is lower than the minimum volume threshold. Accordingly, the passenger audio input detected at time T2 is discarded. The driver audio input, on the other hand, is passed through.

In each of scenarios 408 and 410, a driver audio input and a passenger audio input are both detected by their respective microphones 122A, 122B simultaneously (at time T1). Both audio inputs are above the minimum volume threshold. There is an occupant in each seat. In both scenarios 408 and 410, the passenger audio input is louder than the driver audio input. However, in scenario 408, the volume gap between the passenger audio input and the driver audio input is non-trivial. As described above, this can mean either that the volume gap is greater than a predefined absolute amount, or that the passenger audio input is a predefined percentage louder than the driver audio input. Accordingly, in scenario 408, the passenger side microphone 122B is activated and the passenger audio input is passed through, while the driver side microphone 122A is muted and the driver audio input is discarded. On the other hand, in scenario 410, the volume gap between the passenger audio input and the driver audio input is trivial (that is, less than the predefined absolute or relative amount). Therefore, in scenario 410, both audio inputs are passed through to the application 112.

The foregoing description relates to what are presently considered to be the most practical embodiments. It is to be understood, however, that the disclosure is not to be limited to these embodiments but, on the contrary, is intended to cover various modifications and equivalent arrangements included within the spirit and scope of the appended claims. For example, in the embodiments described above, the vehicle 200 is generally described an automobile. However, the vehicle 200 is not limited to an automobile, as the disclosed systems and methods could also be implemented with other vehicles generally controlled by a driver, or operator, such as airplanes, boats, trains, etc. The scope of the claims is thus to be accorded the broadest interpretation so as to encompass all such modifications and equivalent structures as is permitted under the law.

What is claimed is:

1. A computing device for a vehicle comprising:
one or more processors for controlling operations of the computing device; and
a memory storing data and program instructions used by the one or more processors, wherein the one or more processors execute instructions stored in the memory to:
receive a first audio input from a first microphone biased toward a first seat within the vehicle;
receive a second audio input from a second microphone biased toward a second seat within the vehicle;
compare the first audio input and the second audio input to determine which is louder and which is quieter; and
discard the quieter of the first audio input and the second audio input.

2. The computing device of claim 1, wherein the one or more processors are further configured to execute instructions stored in the memory to send the louder of the first audio input and second audio input to telephone application.

3. The computing device of claim 1, wherein each of the first audio input and the second audio input is discarded if it is quieter than a predefined minimum volume threshold.

4. The computing device of claim 1, wherein the quieter of the first audio input and second audio input is discarded only if a variance between the quieter of the first audio input and second audio input and the louder of the first audio input and second audio input exceeds a predefined volume gap.

5. The computing device of claim 4, wherein the predefined volume gap is an absolute volume difference.

6. The computing device of claim 4, wherein the predefined volume gap is based on a proportion of the louder of the first audio input and the second audio input.

7. The computing device of claim 1, wherein the one or more processors are further configured to execute instructions stored in the memory to:
determine whether an occupant is present in each of the first seat and the second seat based on data received from one or more sensors associated with each seat; and
discard each of the first audio input and the second audio input if there is no occupant in the corresponding seat.

8. The computing device of claim 1, wherein the one or more processors are further configured to execute instructions stored in the memory to display a visual indication identifying the louder of the first audio input and second audio input.

9. A computer-implemented method for a vehicle comprising:
receiving a first audio input from a first microphone biased toward a first seat within the vehicle;
receiving a second audio input from a second microphone biased toward a second seat within the vehicle;
comparing the first audio input and the second audio input to determine which is louder and which is quieter; and
discarding the quieter of the first audio input and the second audio input.

10. The method of claim 9, further comprising sending the louder of the first audio input and second audio input to a telephone application.

11. The method of claim 9, wherein each of the first audio input and the second audio input is discarded if it is quieter than a predefined minimum volume threshold.

12. The method of claim 9, wherein the quieter of the first audio input and second audio input is discarded only if a variance between the quieter of the first audio input and second audio input and the louder of the first audio input and second audio input exceeds a predefined volume gap.

13. The computing device method of claim 12, wherein the predefined volume gap is an absolute volume difference.

14. The method of claim 12, wherein the predefined volume gap is based on a proportion of the louder of the first audio input and second audio input.

15. The method of claim 9, further comprising:
determining whether an occupant is present in each of the first seat and the second seat based on data received from one or more sensors associated with each seat; and
discarding each of the first audio input and the second audio input if there is no occupant in the corresponding seat.

16. The method of claim 9, further comprising displaying a visual indication identifying the louder of the first audio input and second audio input.

17. A system comprising:
a vehicle;
at least a first microphone biased toward a first seat within the vehicle and a second microphone biased toward a second seat within the vehicle;
a computing device in communication with the first microphone and the second microphone, the computing device comprising one or more processors for controlling operations of the computing device and a memory storing data and program instructions used by the one or more processors, wherein the one or more processors execute instructions stored in the memory to:
receive a first audio input from the first microphone;
receive a second audio input from the second microphone;
compare the first audio input and the second audio input to determine which is louder and which is quieter; and
discard the quieter of the first audio input and the second audio input.

18. The system of claim 17, wherein the one or more processors are further configured to execute instructions stored in the memory to send the louder of the first audio input and second audio input to a telephone application.

19. The system of claim 17, wherein the quieter of the first audio input and second audio input is discarded only if a variance between the quieter of the first audio input and second audio input and the louder of the first audio input and second audio input exceeds a predefined volume gap.

20. The system of claim 17, wherein the one or more processors are further configured to execute instructions stored in the memory to:
determine whether an occupant is present in each of the first seat and the second seat based on data received from one or more sensors associated with each seat; and
discard each of the first audio input and the second audio input if there is no occupant in the corresponding seat.
